(19) United States
(12) Patent Application Publication
(10) Pub. No.: US 2008/0232559 A1
(43) Pub. Date: Sep. 25, 2008

(54) METHOD FOR VOICE RESPONSE AND VOICE SERVER

(76) Inventors: Yuetao Meng, Shenzhen (CN); Zhou Yu, Shenzhen (CN); Keping Chen, Shenzhen (CN)

Correspondence Address: BRINKS HOFER GILSON & LIONE, P.O. BOX 10395, CHICAGO, IL, 60610, US

(21) Appl. No.: 12/132,185

(22) Filed: Jun. 3, 2008

Related U.S. Application Data
(63) Continuation of application No. PCT/CN2007/071104, filed on Nov. 21, 2007.

(30) Foreign Application Priority Data
Dec. 26, 2006 (CN) 200610157787.8

(51) Int. Cl. H04M 1/64; G10L 15/26; G10L 11/00; G10L 21/00

(52) U.S. Cl. 379/88.17; 704/235; 704/270.1; 379/220.01; 379/93.01; 704/E15.001; 704/E15.04

(57) ABSTRACT

A voice response method and a voice server. The method comprises: obtaining a voice service request and transforming the voice service request to a text service request; obtaining corresponding voice response data and visual response data according to the text service request; and transmitting the voice response data and visual response data.

### RELATED APPLICATIONS

This application is a continuation application of international application No. PCT/CN2007/071104, filed Nov. 21, 2007, which claims the benefit of Chinese Patent Application No. 200610157787.8, filed Dec. 26, 2006, the contents of which are both incorporated in their entireties by reference.

### FIELD

The present embodiments relate to voice response and a voice server.

### BACKGROUND

The development of voice recognition technology and Voice Over IP (“VoIP”), together with the newly emerged advanced “voice server” (in contrast with keystroke-style menu selection), promote all automatic Interactive Voice Response (“IVR”) applications. A user may implement end-to-end service with an enterprise or operator through such applications. For example, when a customer calls a service hotline of a consumption household electrical appliances manufacturer and speaks “refrigerator”, the customer will be connected to a relevant department, which reduces the calling time. In the field of telecom value-added service such as Number Best Tone, the operator also provides user experience of voice recognition. In another application field of data entry, the voice technology is significantly advantageous over the keystroke-style IVR. For example, some U.S. Airlines advocate all automatic systems recently for people to book a ticket through telephone. Such applications would be impossible with only the keystroke-style dial-up.

In the voice technologies, a user interacts with a system via acoustical organs and voices. An interface for this is known as a Voice User Interface (“VUI”). The VUI presents a correct result for the first interaction so as to reduce the number of times of user confirmation and the number of times of returning from error at most.

The following example shows an interaction between a user and a flight information system:

System: Hello, thanks for calling “Blue Sky” Airlines. Our newest automatic system may help you to inquire about flight information you need. Do you know the flight number?

User: Sorry, I don't know.

System: Never mind, tell me the departure city of the flight, please.

User: Beijing.

Referring to FIG. 1, an automatic IVR system includes a telephone, an exchange, and a voice server. The voice server includes a service processing module, a service control module and a voice processing module. The service control module is connected to the exchange. The flow of the IVR system shown in FIG. 1 is discussed below.

A user dials a telephone number of the voice server via the telephone, and the exchange switches on a transmission channel between the telephone and the voice server.

The voice server plays a salutatory or operation prompt. More specifically, the service control module obtains a text response from the service processing module, the service control module invokes (uses) a TTS (Text to Speech) technology of the voice processing module to transform the text response into speech, and the service control module sends the speech to the telephone via the exchange.

The user interacts with the voice server via voices, the service control module forwards the voices from the telephone to the voice processing module. The voice processing module performs ASR (Automatic Speech Recognition) and returns text to the service control module. The service control module forwards the text to the service processing module.

If the voices are recognized as text correctly, the service processing module implements the service and instructs the result to the user. If the voices are not recognized or are ambiguous, the service processing module prompts the user to confirm the result or error.

The user continues to interact with the voice server via voices, or hangs up.

In FIG. 1, the user inputs voice response and the voice server instructs or requests the user's confirmation. However, when the voice server cannot recognize a voice or the recognized voice involves ambiguity, voice interactive tones are often used to request the user to confirm the ambiguity or initiate a new voice operation. In such a case, if the speed of playing the prompting voices is controlled to be too high, the tones are difficult to understand and are easy to be forgotten, while a low playing speed should make the user lose patience. Further, in a noisy environment, noises also affect the audition of the user. Though the prompt tones may be played repeatedly, this intends to cause antipathy of the user.

The IVR system shown in FIG. 1 has a poor interactive interface, which may slow down the voice interactive system because the user may continue to use the system only after hearing and understanding the prompts. In addition, the IVR system shown in FIG. 1 plays prompt tones repeatedly, which often causes antipathy of users.

### SUMMARY

The present embodiments may obviate one or more of the drawbacks or limitations inherent in the related art. For example, in one embodiment, a voice server provides a visual interface while providing a voice recognition interactive interface.

In one embodiment, a voice response method includes obtaining a voice service request; transforming (generating) the voice service request into a text service request; obtaining corresponding voice response data and visual response data according to the text service request; and transmitting the voice response data and the visual response data.

In one embodiment, a voice server includes a service processing module, a service control module and a voice processing module. The voice processing module transforms a received voice service request into a text service request. The service processing module obtains corresponding voice response data and visual response data according to the text service request. The service control module may transmit the voice response data and visual response data.

In one embodiment, a man-machine interactive interface provides a combination of voices and visual response data. The interaction may provide a visual interface even when prompt tones are not recognizable. The user voice interruption is allowed to respond to the result even before the end of the prompt tones, so as to the speed up the voice interaction. The interactive interface does not repeatedly play prompt tones when a user does not understand or hear the prompt tones.

### BRIEF DESCRIPTION OF THE DRAWINGS

FIG. 1 is a schematic diagram illustrating the structure of an automatic IVR system of the related art;

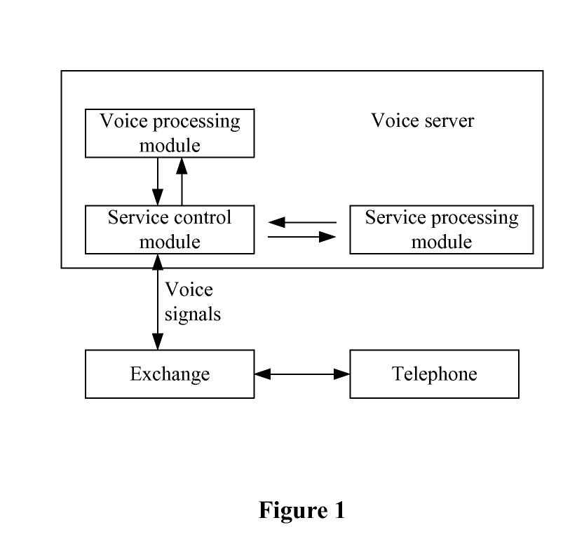

FIG. 2 is a schematic diagram illustrating the structure of an automatic IVR system according to one embodiment;

FIG. 3 is a schematic diagram illustrating the flow of a voice response method according to one embodiment; and

FIG. 4 is a schematic diagram illustrating the flow of a voice response method according to SIP according to one embodiment.

### DETAILED DESCRIPTION

Embodiments will be illustrated with reference to the accompanying drawings.

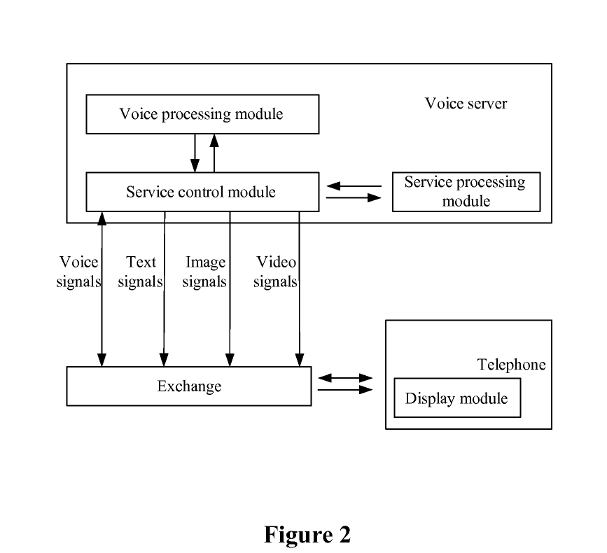

FIG. 2 shows an Interactive Voice Response (“IVR”) system. The IVR system includes a telephone, an exchange, and a voice server.

The voice server includes a service processing module, a service control module, and a voice processing module. The service control module is connected to the exchange. The voice processing module is adapted (operable) to transform a received voice service request into a text service request. The voice service request may be obtained from the service control module or directly through an interface. Voice response data and visual response data (such as, text messages, images, and streaming media) associated with the text service request are stored in the service processing module. The service processing module obtains corresponding voice response data and visual response data according to the text service request. The service control module is connected to the service processing module, and is adapted to control the service processing module and return voice response data and visual response data obtained by the service processing module to the telephone via the exchange, so as to provide the voice response data and visual response data to the user.

The telephone includes a display module. The voice server transmits texts (text messages), images, or streaming media to the telephone while transmitting voices. The voice server may use a communication channel, an audio communication channel, and signaling for transmission. The telephone displays texts, images, or streaming media contents using the display module.

The IVR system may be used to display a synthetic face (e.g., a virtual compere) while listening to voices of a computer. The synthetic face makes the man-machine interactive interface more friendly and harmonious.

The voice server includes a transforming unit and a second voice processing module when the service processing module has text response data associated with a text service request. The transforming unit may be an independent module or in the service control module. The transforming unit is adapted to transform text response data into images and/or media streams. The second voice processing module is adapted to transform text response data into voice response data. The second voice processing module may be an independent module or set in the voice processing module. In this case, the service control module is adapted to control the service processing module to obtain text response data from the service processing module. The service control module may invoke (use) Text to Speech (“TTS”) technology of the second voice processing module to transform the text response data into voice response data. The service control module may control the transforming unit to invoke (use) Text-to-Visual Speech (“TTVS”) technology to transform text response data into images or streaming media.

The telephone voice system provides accessorial texts, a graphic visual interface, or video interface, in addition to (in combination with) a voice interactive interface. The speed and efficiency of voice interaction are improved by combination of voices and visual information. The man-machine interactive interface is friendly and harmonious.

The voice, text, image, and video data may be transmitted on any transport network or protocol. For example, the texts (text messages), images, and streaming media may be transferred through a Public Switched Telephone Network (“PSTN”), an Internet Protocol (IP)-based switch network, and IP-based protocols (such as session initiation protocol (“SIP”)). The telephone may be a VOIP telephone, a plain old telephone service (“POTS”) telephone, an intelligent terminal, or a mobile phone.

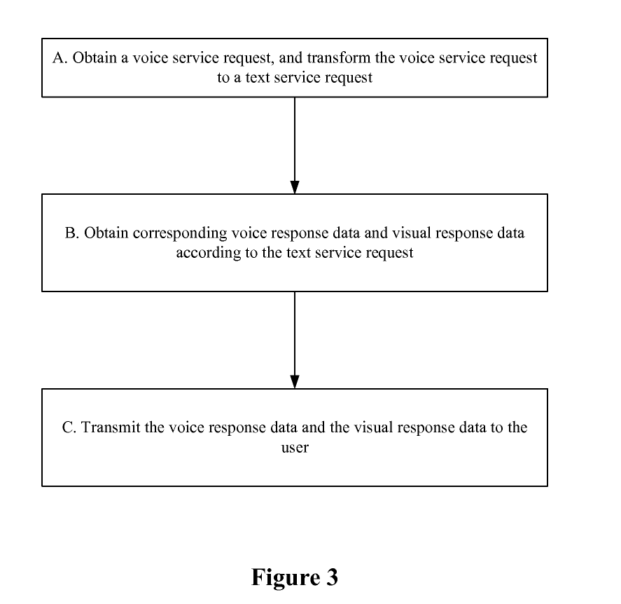

FIG. 3 illustrates one embodiment of a voice response method. The method includes obtaining a voice service request of a user and transforming the voice service request into a text service request; obtaining corresponding voice response data and visual response data according to (associated with) the text service request; transforming the text response data into voice response data, images and/or streaming media; and transmitting the voice response data and visual response data to the user. The visual response data includes at least one type of text, image, and streaming media.

Obtaining corresponding voice response data and visual response data according to (associated with) the text service request may include obtaining the corresponding voice response data and/or visual response data directly according to the text service request if there is voice response data and/or visual response data associated with the text service request. Obtaining corresponding voice response data and visual response data according to (associated with) the text service request may include obtaining the corresponding text response data according to the text service request if there is text response data associated with the text service request.

If the visual response data is text or an image, the text or the image is transmitted to the user through signaling. If the visual response data are streaming media, a streaming media communication channel is established and the streaming media is transmitted to the user through the streaming media communication channel.

The method further includes determining the visual response data to be transmitted to the user. Determining the visual response data may include receiving information on service capability that the terminal supports reported by the user, and determining corresponding visual response data according to the information on service capability.

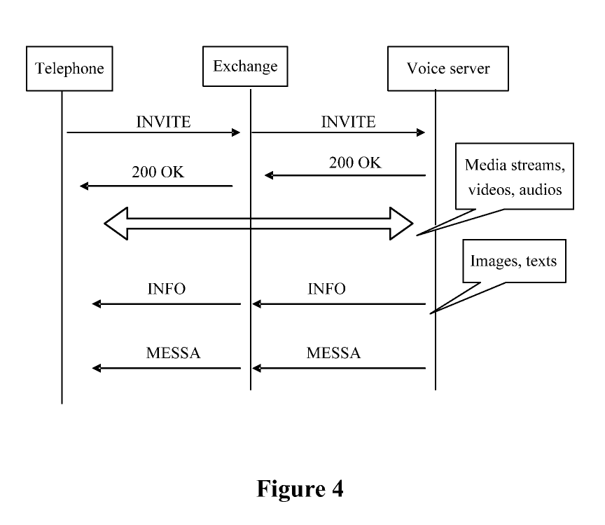

FIG. 4 illustrates one embodiment of a voice response using a Session Initiation Protocol (“SIP”).

The telephone transmits an INVITE message to the voice server when a user dials the number. The voice server returns a 200OK message. The INVITE message and 200OK message carry an identifier indicating whether the telephone supports text messages, images, or streaming media, and carries a Session Description Protocol (SDP) that describes the media streaming.

An audio communication channel is established between the telephone and the voice server after SDP negotiation on the INVITE and 200OK messages bearing SDP. If it is determined that the telephone supports text messages, text messages are exchanged between the telephone and the voice server via signaling and voices are exchanged through the audio communication channel. If it is determined that the telephone supports streaming media, a video communication channel is established between the telephone and the voice server, and streaming media is exchanged through the video communication channel between the telephone and the voice server. If it is determined that the telephone supports image information, images are exchanged via signaling between the telephone and the voice server.

The following example illustrates using SIP to transmit voice response data and visual response data.

In the example, a user dials 911, and the telephone transmits an INVITE message as follows:

| | |
|---|---|
| INVITE SIP: 911 SIP/2.0 | // initiates a call to 911 |
| Allow : MESSAGE, INFO,.... | // the telephone supports MESSAGE, |
| INFO messages | |
| ... | |
| Content-Type : application/SDP | // following are contents of the |

```
message and the message contents conform to SDP
  ...
  c = IN IP4 191.169.1.112 // the telephone intends to receive and
transmit media data by IP address 191.169.1.112
  m = audio 14380 RTP/AVP 0 96 97 98 // the port of the
telephone for receiving/transmitting audio is 14380
```

| | |
|---|---|
| a = rtpmap:0 PCMU | // audio encoding method |
| ... | |

| | |
|---|---|
| m = video 3400 RTP/AVP 98 99 | // the port of the telephone for |

receiving/transmitting video is 3400

| | |
|---|---|
| a = ... | // video encoding method |
| (omitted) | |

The telephone transmits an INVITE message to the voice sever, indicating that it intends to establish a video channel and an audio channel, and informing the voice server that the telephone supports text messages (MESSAGE) and supports images (INFO). The telephone returns a 200OK message as follows:

```
  SIP/2.0 200OK
  ...
  Content-Type: application/SDP
  m=audio 14380 RTP/AVP 0 96 97 98 // the port of the voice server
for receiving/transmitting audio is 14380
  a=rtpmap:0 PCMU // audio encoding method
  ....
  m=video 3400 RTP/AVP 98 99 // the port of the voice server for
receiving/transmitting video is 3400
  A video and audio media stream is established after the voice server
returns the 200OK message.
  Allow: MESSAGE, INFO,... // supports MESSAGE, INFO
messages
```

Using the MESSAGE and INFO of an Allow field in the INVITE message, the voice server determines that the telephone accepts text messages and images. The text messages are sent via the MESSAGE and images are sent via the INFO.

The specific standards are as follows:

RFC3261 describes SIP protocol.

RFC3364 describes the session negotiation of SDP.

RFC3428 describes receiving and transmitting texts of MESSAGE.

RFC2976 describes an INFO message.

In a PSTN network, the above functions and standards may be implemented via an H.320 protocol.

In addition, the exchange in the IVR system may be substituted with a software-switching device or a router.

Those skilled in the art will understand that the present embodiments can be implemented with software and necessary hardware, or entirely with hardware, but in many cases, the former is preferred. Based on such understanding, the contribution of the solution of the invention to the prior art may be entirely or partially achieved by software, the software may be stored in a storage medium such as a ROM/RAM, a magnetic disk, an optical disk, the software includes instructions for making a computer device (personal computer, server or network device etc.) carry out the method of embodiments or parts of an embodiment of the present invention.

The preferred embodiments of the present invention were discussed above and by no way to limit the scope of the present invention. Any modifications, alternations, and improvements made within the spirit and principle of the present invention will fall into the scope of the invention as defined by the accompanying claims.

1. A voice response method comprising:
obtaining a voice service request;
transforming the voice service request into a text service request;
obtaining corresponding voice response data and visual response data according to the text service request; and
transmitting the voice response data and visual response data.

2. The voice response method of claim 1, further comprising:
receiving service capability information; and
determining the visual response data according to the service capability information.

3. The voice response method of claim 1, wherein the visual response data comprises text messages, images, streaming media, or any combination thereof.

4. The voice response method of claim 1, wherein obtaining corresponding voice response data and visual response data according to the text service request comprises:
obtaining corresponding text response data according to the text service request; and
transforming the text response data into the voice response data.

5. The voice response method of claim 1, wherein obtaining corresponding voice response data and visual response data according to the text service request comprises:
obtaining corresponding text response data according to the text service request; and
transforming the text response data into the visual response data.

6. The voice response method of claim 3, further comprising:
transmitting the text messages, or images via signaling.

7. A voice server comprising:
a voice processing module that is operable to transform a received voice service request into a text service request;
a service processing module that is operable to obtain corresponding voice response data and visual response data associated with the text service request; and
a service control module that is operable to transmit the voice response data and visual response data.

8. The voice server of claim 7, wherein the voice response data and visual response data associated with the text service request are stored in the service processing module.

9. The voice server of claim 7, wherein text response data associated with the text service request are stored in the service processing module, and the voice server comprises a second voice processing module adapted to transform the text response data into the voice response data.

10. The voice server of claim 7, wherein text response data associated with the text service request are stored in the service processing module, and the voice server comprises a transforming unit adapted to transform the text response data into the visual response data.

11. The voice server of claim 7, wherein the service control module is operable to transmit the voice response data and visual response data on a Public Switched Telephone Network (“PSTN”) or an Internet Protocol (IP)-based switch network.

12. The voice server of claim 7, wherein the service control module is operable to transmit the voice response data and visual response data using session initiation protocol.

13. The voice response method of claim 3, further comprising:
establishing a streaming media communication channel; and
transmitting the streaming media via the streaming media communication channel.

14. The voice response method of claim 3, further comprising:
transmitting the text messages or images via signaling; and
transmitting the streaming media via the streaming media communication channel.

15. A voice response method comprising:
receiving an invite message from a telephone using session initiation protocol (SIP), the invite message including an identifier that indicates whether the telephone supports text messages, images, and/or streaming media;
establishing an audio communication channel with the telephone;
transmitting text messages, images and/or streaming media to the telephone based on the whether the telephone supports text messages, images, and/or streaming media,

16. The voice response method of claim 15, wherein transmitting text messages, images and/or streaming media to the telephone comprises transmitting text messages, images and/or streaming media in response to a voice signal.

17. The voice response method of claim 15, wherein transmitting text messages, images and/or streaming media includes:
obtaining a voice service request via the audio communication channel;
generating a text service request based on the voice service request;
obtaining corresponding text messages, images and/or streaming media according to the text service request; and
transmitting the corresponding text messages, images and/or streaming media.

18. The voice response method of claim 15, wherein if it is determined that the telephone supports streaming media, a video communication channel is established between the telephone and the voice server and streaming media is exchanged through the video communication channel between the telephone and the voice server.

19. The voice response method of claim 15, wherein if it is determined that the telephone supports image information, images are exchanged via signaling between the telephone and the voice server.
